(19) United States
(12) Patent Application Publication
(10) Pub. No.: US 2014/0078743 A1
(43) Pub. Date: Mar. 20, 2014

(54) MOUNTING STRUCTURE OF A LAMP ASSEMBLY

(71) Applicant: TAIWAN FU HSING INDUSTRIAL CO., LTD., Kaohsiung City (TW)

(72) Inventors: Shun-Ho Wu, Kaohsiung City (TW); Chih-Cheng Huang, Kaohsiung City (TW)

(73) Assignee: Taiwan Fu Hsing Industrial Co., Ltd., Kaohsiung City (TW)

(21) Appl. No.: 13/739,205

(22) Filed: Jan. 11, 2013

(30) Foreign Application Priority Data
Sep. 14, 2012 (TW) 101133903

(51) Int. Cl. F21V 21/00; F21V 29/00

(52) U.S. Cl. CPC F21V 21/00; F21V 29/004
USPC 362/294; 362/311.01

(57) ABSTRACT

A mounting structure of a lamp assembly at least includes a first mounting base and a second mounting base, the second mounting base is attached to the first mounting base, the first mounting base comprises a blocking portion, and the second mounting base comprises a limiting portion and a clamping portion. The blocking portion of the first mounting base is limited between the clamping portion and the limiting portion to prevent the second mounting base from separating the first mounting base.

### FIELD OF THE INVENTION

The present invention is generally related to a mounting structure of a lamp assembly, which particularly relates to the mounting structure of the lamp assembly with a first mounting base and a second mounting base.

### BACKGROUND OF THE INVENTION

Please referring to Taiwan patent application number 097223212 “LIGHT-EMITTING DIODE LAMP”, wherein the light-emitting diode lamp includes a lamp lid and a colored light-permeable cover. The colored light-permeable cover comprises an opening, and an accommodating slot of the lamp lid is covered with the colored light-permeable cover. The lamp lid comprises an upper surface located at a top peripheral of the accommodating slot, and the colored light-permeable cover is disposed on the upper surface. The lamp lid comprises a first ring-shaped structure located on the upper surface and utilized for accommodating the colored light-permeable cover to prevent the colored light-permeable cover from sliding along the upper surface. However, the upper surface merely bears the colored light-permeable cover so that the colored light-permeable cover likely separates apart from the lamp lid.

Furthermore, FIG. 3 of light-emitting diode lamp discloses that the colored light-permeable cover is coupled to the lamp lid via a hook design. However, flexible material of the hook itself likely leads to crack for reasons of aging, over temperature or careless installation. In addition, an unaesthetic problem exists owning to the hook revealed by a heat-dissipating slot of the colored light-permeable cover. When the colored light-permeable cover couples to the lamp lid, a gap between the colored light-permeable cover and the lamp lid is clearly visible. Rather than adopting a cladding design, the user might consider that the coupling strength is insufficient.

Otherwise, the circuit board of the light-emitting diode lamp is secured by using screws, which not only increases the overall weight, but also raises the cost and the time for assembling screws into the circuit board.

### SUMMARY

The primary object of the present invention is to provide a mounting structure of a lamp assembly, wherein a second mounting base of the mounting structure is combined with the first mounting base via a bending design to simply the assembly of the mounting structure of the lamp assembly. The present invention possesses a better appearance. Besides, the user considers the mounting structure highly secured.

A mounting structure of a lamp assembly in the present invention includes a lighting module disposed on the mounting module and a lamp cover for dispersing light from the lighting module, wherein the mounting structure at least includes a first mounting base and a second mounting base mutually combined with the first mounting base. The first mounting base comprises a blocking portion, the second mounting base comprises a limiting portion and a clamping portion connected to the limiting portion, wherein the clamping portion is deformable in response to forces. The blocking portion of the first mounting base is limited between the clamping portion and the limited portion so as to make the blocking portion formed as a concealed state. In the present invention, the blocking portion of the first mounting base is clamped by the clamping portion and the limiting portion to prevent the second mounting base from separating the first mounting base.

### DESCRIPTION OF THE DRAWINGS

FIG. 1 is a perspective exploded view illustrating a mounting structure of a lamp assembly in accordance with a first embodiment of the present invention.

FIG. 2 is a perspective assembly view illustrating the mounting structure of the lamp assembly in accordance with the first embodiment of the present invention.

FIG. 3 is a perspective assembly view illustrating the mounting structure of the lamp assembly in accordance with the first embodiment of the present invention.

FIG. 4 is a perspective assembly view illustrating the mounting structure of the lamp assembly in accordance with a second embodiment of the present invention.

FIG. 5 is a section view illustrating the mounting structure of the lamp assembly in accordance with the second embodiment of the present invention.

FIG. 6 is a perspective assembly view illustrating the mounting structure of the lamp assembly in accordance with a third embodiment of the present invention.

FIG. 7 is a perspective exploded view illustrating the mounting structure of the lamp assembly in accordance with a fourth embodiment of the present invention.

FIG. 8 is a section view illustrating the mounting structure of the lamp assembly in accordance with the fourth embodiment of the present invention.

FIG. 9 is a perspective exploded view illustrating the mounting structure of the lamp assembly in accordance with a fifth embodiment of the present invention.

FIG. 10 is a schematic diagram illustrating a way for assembling a substrate and a second mounting base in accordance with the fifth embodiment of the present invention.

FIG. 11 is a schematic diagram illustrating a way for assembling the substrate and the second mounting base in accordance with the fifth embodiment of the present invention.

FIG. 12 is a schematic diagram illustrating a way for assembling the substrate and the second mounting base in accordance with the fifth embodiment of the present invention.

FIG. 13 is a perspective exploded view illustrating the mounting structure of the lamp assembly in accordance with a sixth embodiment of the present invention.

FIG. 14 is a schematic diagram illustrating a way for assembling the substrate and the second mounting base in accordance with the sixth embodiment of the present invention.

FIG. 15 is a schematic diagram illustrating a way for assembling the substrate and the second mounting base in accordance with the sixth embodiment of the present invention.

FIG. 16 is a schematic diagram illustrating a way for assembling the substrate and the second mounting base in accordance with the sixth embodiment of the present invention.

FIG. 17 is a perspective exploded view illustrating the mounting structure of the lamp assembly in accordance with a seventh embodiment of the present invention.

FIG. 18 is a schematic diagram illustrating a way for assembling the substrate and the second mounting base in accordance with the seventh embodiment of the present invention.

FIG. 19 is a schematic diagram illustrating a way for assembling the substrate and the second mounting base in accordance with the seventh embodiment of the present invention.

FIG. 20 is a schematic diagram illustrating a way for assembling the substrate and the second mounting base in accordance with the seventh embodiment of the present invention.

FIG. 21 is a schematic diagram illustrating the mounting structure of the lamp assembly in accordance with an eighth embodiment of the present invention.

FIG. 22 is a lateral section view illustrating the mounting structure of the lamp assembly in accordance with the eighth embodiment of the present invention.

### DETAILED DESCRIPTION OF THE INVENTION

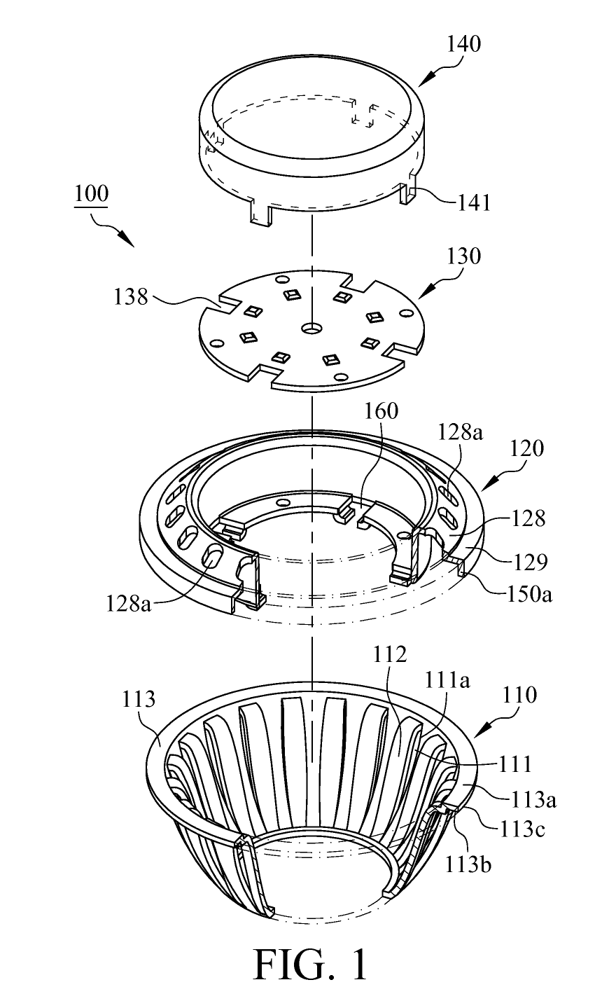

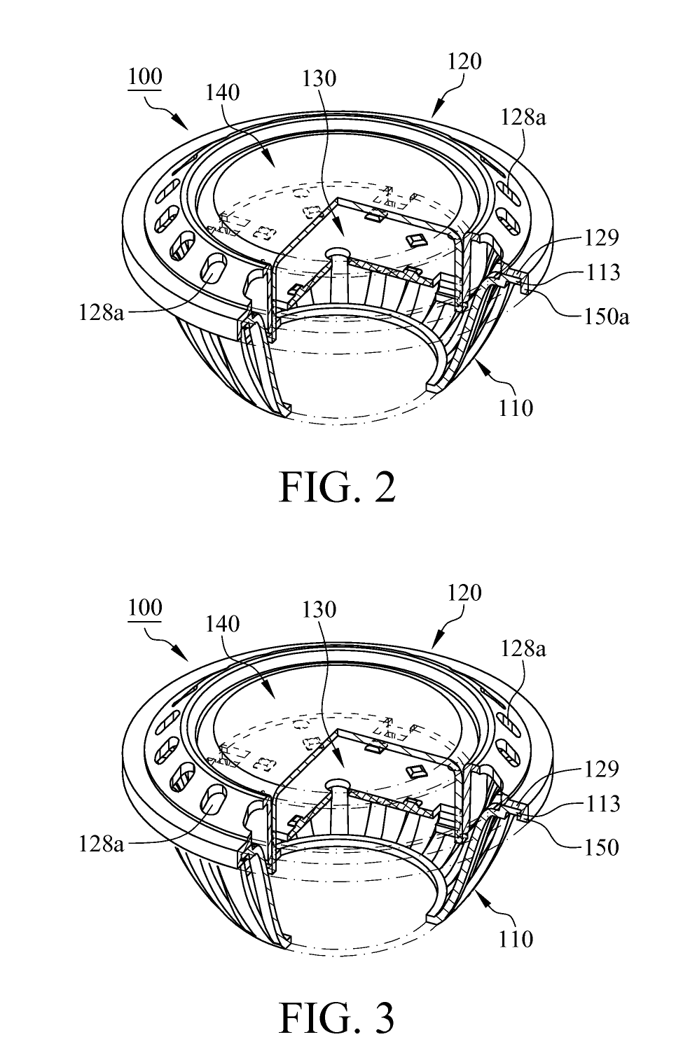

With reference to FIGS. 1 and 2, a mounting structure 100 of a lamp assembly in accordance with a first embodiment of the present invention is disclosed, the lamp assembly includes a lighting module 130 disposed on the mounting structure 100 and a lamp cover 140 for dispersing lights from the lighting module 130, the lighting module 130 comprises a plurality of openings 138, and the lamp cover 140 comprises a plurality of insertion plates 141. The mounting structure 100 at least includes a first mounting base 110 and a second mounting base 120 mutually combined with the first mounting base 110, and the lighting module 130 is coupled to the second mounting base 120. The first mounting base 110 comprises a plurality of heat-dissipating openings 111, a plurality of heat-dissipating ribs 112 and a blocking portion 113, wherein each of the heat-dissipating openings 111 comprises a lateral wall 111a, each of the heat-dissipating ribs 112 is formed at each of the lateral walls 111a for increasing heat dissipation efficiency, and the blocking portion 113 comprises a top surface 113a, a bottom surface 113b and a lateral surface 113c connected to the top surface 113a and the bottom surface 113b. The second mounting base 120 comprises a heat-dissipating portion 128, a limiting portion 129 connected to the heat-dissipating portion 128, a body portion 150a connected to the limiting portion 129 and a plurality of insertion slots 160, wherein each of the insertion plates 141 is lodged into each of the insertion slots 160 of the second mounting base 120 via each of the openings 138 of the lighting module 130 thereby making the lighting module 130 firmly coupled between the lamp cover 140 and the second mounting base 120. The heat-dissipating portion 128 comprises a plurality of heat-dissipating holes 128a, and the limiting portion 129 is located between the heat-dissipating portion 128 and the body portion 150a. Referring to FIG. 2, the second mounting base 120 is combined with the first mounting base 110. With reference to FIG. 3, bending the body portion 150a toward the location of the first mounting base 110 makes the body portion 150a formed into an L-shaped clamping portion 150. In this embodiment, the clamping portion 150 is deformable in response to forces and surrounds the blocking portion 113. Besides, the clamping portion 150 is not pushed and compressed by the blocking portion 113 so that the clamping portion 150 is not deformed. Oppositely, the clamping portion 150 is deformed while an exerting force is applied to the clamping portion 150 so as to make the blocking portion 113 of the first mounting base 110 limited between the clamping portion 150 and the limiting portion 129 therefore forming into a concealed state. In this embodiment, the top surface 113a, the bottom surface 113b and the lateral surface 113c are concealed by the clamping portion 150 and the limiting portion 129. The present invention prevents the second mounting base 120 from separating the first mounting base 110 for the reason that the blocking portion 113 of the first mounting base 110 is clamped by the clamping portion 150 and the limiting portion 129.

Furthermore, the clamping portion 150 and the limiting portion 129 of the present invention adopt a cladding design, which effectively overcomes an unaesthetic problem caused by exposing a hook exteriorly in the prior art, additionally, the user considers it highly secured for the reason that the first mounting base 110 is cladded by the second mounting base 120. Comparatively, the hook in the prior art easily leads to crack owning to problems of aging, over temperature or careless installation.

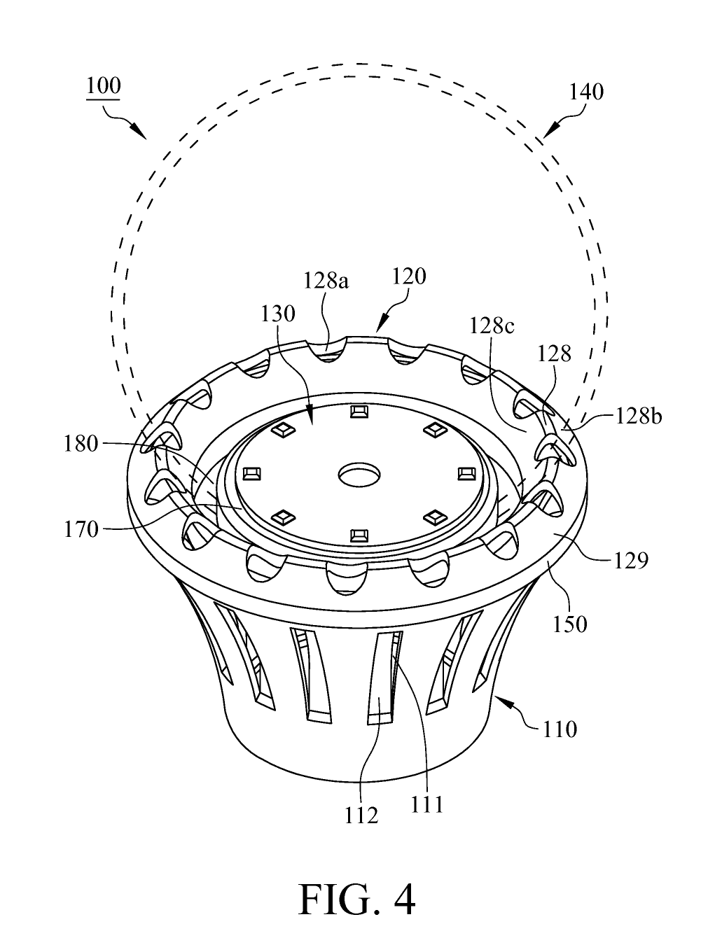

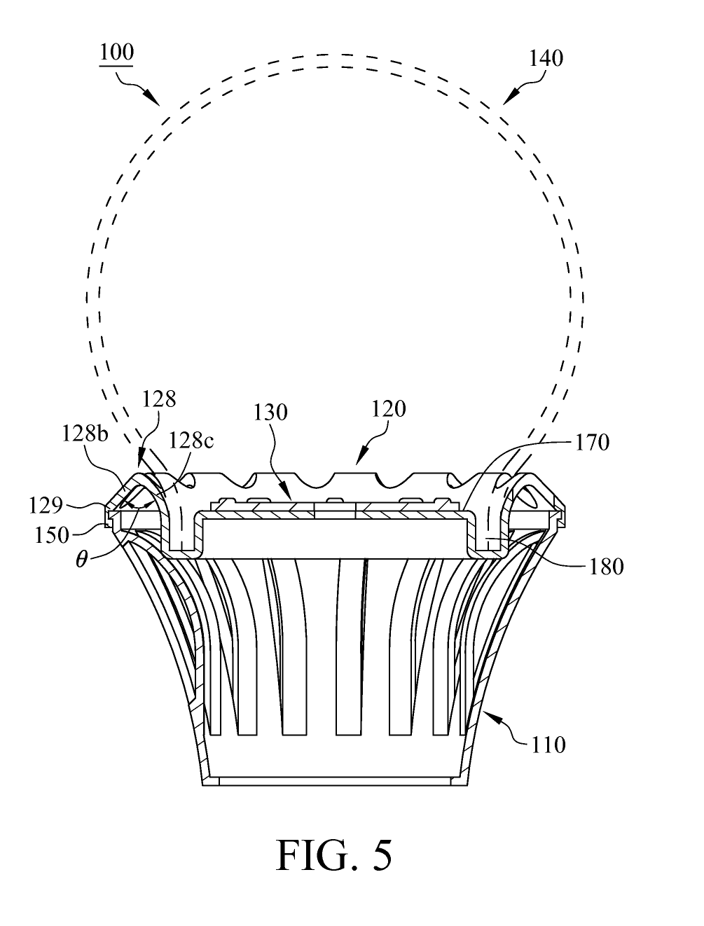

With reference to FIGS. 4 and 5, a second embodiment of the present invention is disclosed, the primary difference between the second embodiment and the first embodiment is that the second mounting base 120 further comprises an attaching portion 170 coupled to the lighting module 130 and a recess portion 180 coupled to the lamp cover 140, the recess portion 180 is located between the attaching portion 170 and the heat-dissipating portion 128, and the height of the recess portion 180 is lower than that of the attaching portion 170 and the heat-dissipating portion 128. When the lamp cover 140 is coupled to the second mounting base 120, the lamp cover 140 is surrounded by the heat-dissipating portion 128, and the lighting module 130 is covered by an interior of the lamp cover 140. Besides, the heat-dissipating portion 128 comprises a first heat-dissipating portion 128b and a second heat-dissipating portion 128c, wherein the first heat-dissipating portion 128b is located between the limiting portion 129 and the second heat-dissipating portion 128c. An included angle θ defined by the first heat-dissipating portion 128b and the second heat-dissipating portion 128c is not larger than 180 degrees, and the heat-dissipating holes 128a of the heat-dissipating portion 128 are formed at the first heat-dissipating portion 128b and the second heat-dissipating portion 128c.

The heat-dissipating holes 128a of the heat-dissipating portion 128 dissipate the heat generated from illuminated lighting module 130 via heat convection theory. Besides, a relatively low-temperature air from exterior environment can be inhaled into the heat-dissipating openings 111 of the first mounting base 110 therefore achieving heat-dissipating effectiveness.

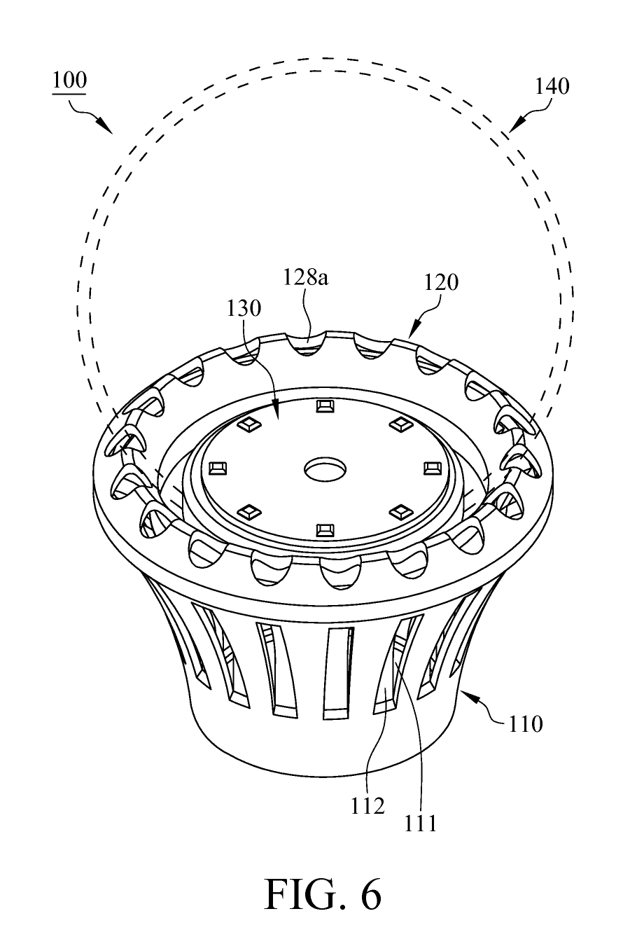

Referring to FIG. 6, a third embodiment of the present invention is disclosed, the primary difference between the third embodiment and the second embodiment is that the quantities of the heat-dissipating holes 128a, the heat-dissipating openings 111 and the heat dissipating ribs 112 are more than that of the second embodiment, which enables to increase the heat-dissipating rate of the mounting structure 100 of the lamp assembly.

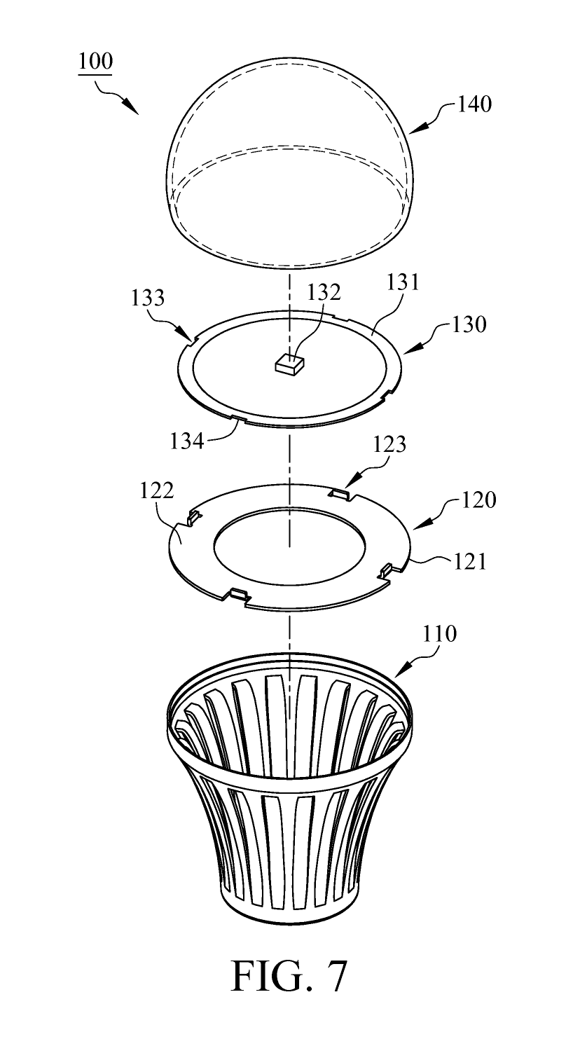

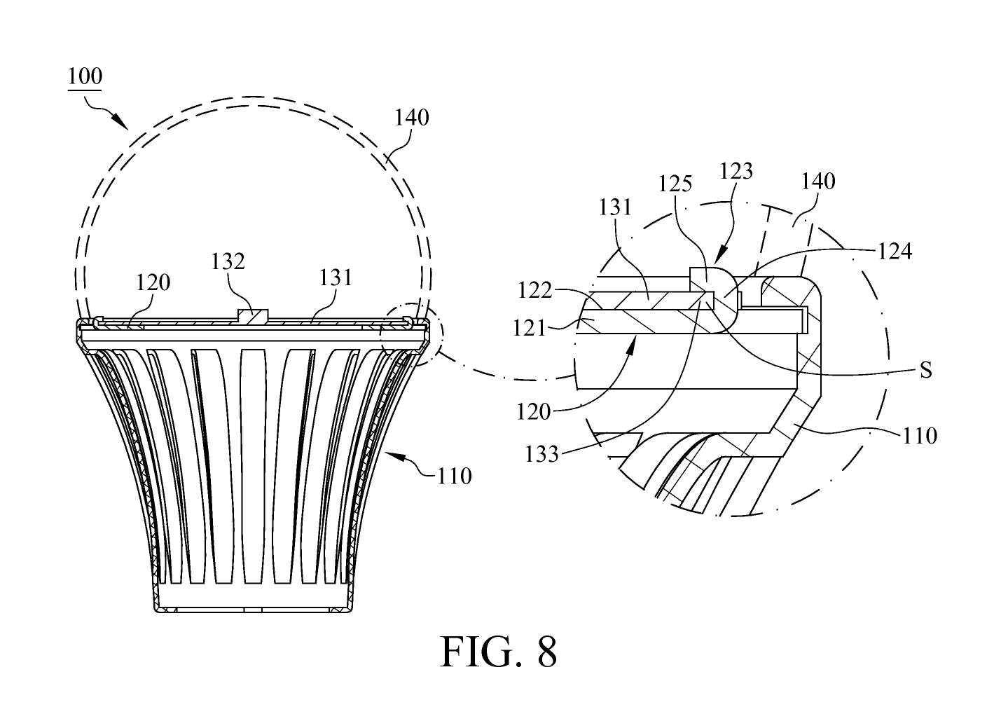

With reference to FIGS. 7 and 8, a fourth embodiment of the present invention is disclosed, a mounting structure 100 of a lamp assembly at least includes a first mounting base 110, a second mounting base 120, a lighting module 130 and a lamp cover 140, wherein the second mounting base 120 disposed at the first mounting base 110 includes a bearing board 121 and a plurality of limiting members 123. In this embodiment, the bearing board 121 is made as one piece with the limiting members 123 via stamping process, and the bearing board 121 comprises a bearing surface 122. Referring to FIG. 8, each of the limiting members 123 comprises a first positioning board 124 connected to the bearing board 121, a second positioning board 125 connected to the first limiting board 124 and a limiting space S. In this embodiment, by bending each of the limiting members 123, the limiting space S is formed between the second positioning boards 125 and the bearing surface 122. The lighting module 130 disposed on the bearing surface 122 of the bearing board 121 comprises a substrate 131 and at least one illuminating device 132 disposed at the substrate 131, and the substrate 131 is constrained within the limiting space S. With reference to FIG. 7, the substrate 131 comprises a plurality of positioning portions 133, and each of the positioning portions 133 is limited by each of the limiting members 123. In this embodiment, the positioning portions 133 are a plurality of positioning holes 134, each of the positioning holes 134 is recessed from an exterior peripheral of the substrate 131, and the first positioning board 124 of each of the limiting members 123 is limited within each of the positioning holes 134.

Referring to FIGS. 7 and 8, the way of combination between the second mounting base 120 and the substrate 131 is described as below: disposing the substrate 131 onto the bearing surface 122 after making each of the positioning holes 134 and each of the limiting members 123 of the second mounting base 120 directly aligned; bending each of the limiting members 123 to make the limiting space S formed between the second positioning board 125 and the bearing surface 122, wherein the substrate 131 is constrained within the limiting space S to prevent the substrate 131 from upwardly separating the second mounting base 120, and the substrate 131 is constrained within the first positioning board 124 via each of the positioning holes 134 to prevent the substrate 131 from clockwise/counterclockwise rotation to avoid damage of electrical wires (not shown in Figs.) or circuit board (not shown in Figs.) connected to the lighting device 132.

Additionally, by adopting a bending design of each of the limiting members 123, the limiting members 123 can be fixedly coupled to the lighting module 130 to replace conventional fixing screws. The overall design of the present invention not only omits the weight of fixing screws, but also saves the cost and the time for assembling fixing screws into the lighting module 130.

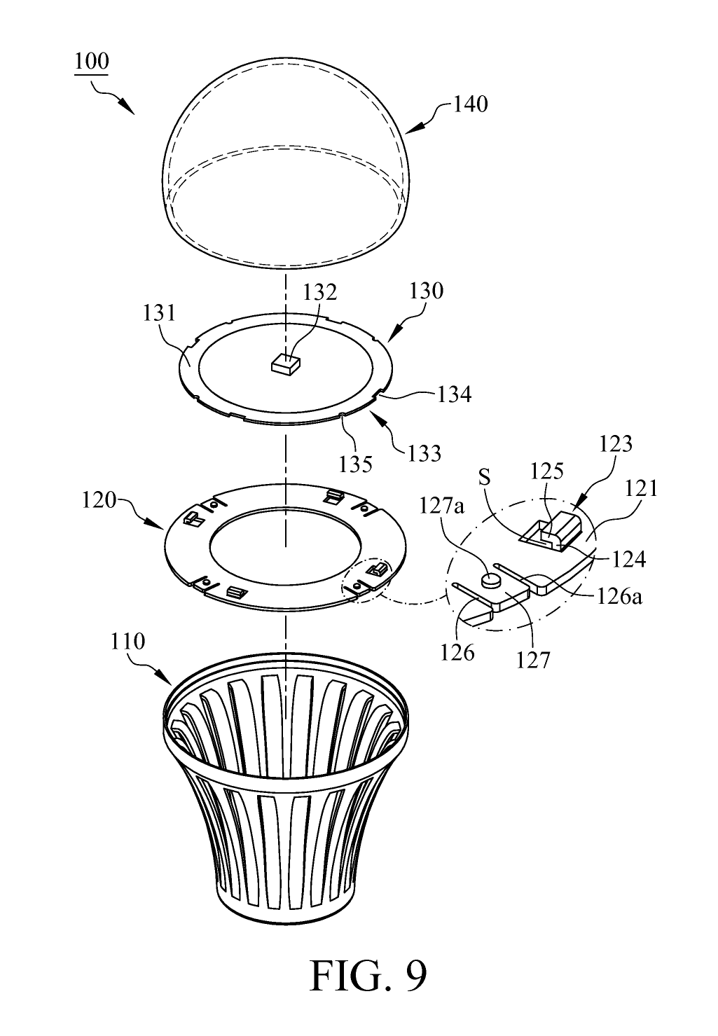

A fifth embodiment of the present invention is disclosed in FIG. 9, the primary difference between the fifth embodiment and the fourth embodiment is that the second mounting base 120 further includes a first coupling feature and a second coupling feature, and the substrate 131 includes a third coupling feature corresponded to the first coupling feature and a fourth coupling feature corresponded to the second coupling feature. The first and third coupling features are not mutually aligned, and the second and fourth coupling features are not mutually aligned as well. When a predetermined rotation angle is formed by performing mutual rotation of the second mounting base 120 and the substrate 131, the state between the first and third coupling features and the state between the second and fourth coupling features can be switched into a coupling state. The coupled relation between the first and third coupling features is utilized for limiting the substrate 131 from rotation. The coupled relation between the second and fourth coupling features is to make the substrate 131 firmly stackable to the second mounting base 120 rather than axially or radially separating the second mounting base 120.

The first coupling feature further includes a plurality of accommodating holes 126 and a plurality of elastic positioning boards 127, and each of the accommodating holes 126 is recessed to an exterior peripheral of the bearing board 121 and comprises an accommodating wall 126a. Each of the elastic positioning boards 127 is connected to each of the accommodating walls 126a and comprises a positioning pillar 127a. The limiting member 123 of the second mounting base 120 is integrally formed to be a bending design under stamping process, and the second coupling feature is the limiting member 123. The third coupling feature further comprises a plurality of limiting holes 135 recessed to an exterior peripheral of the substrate 131. The fourth coupling feature is a top surface of the substrate 131.

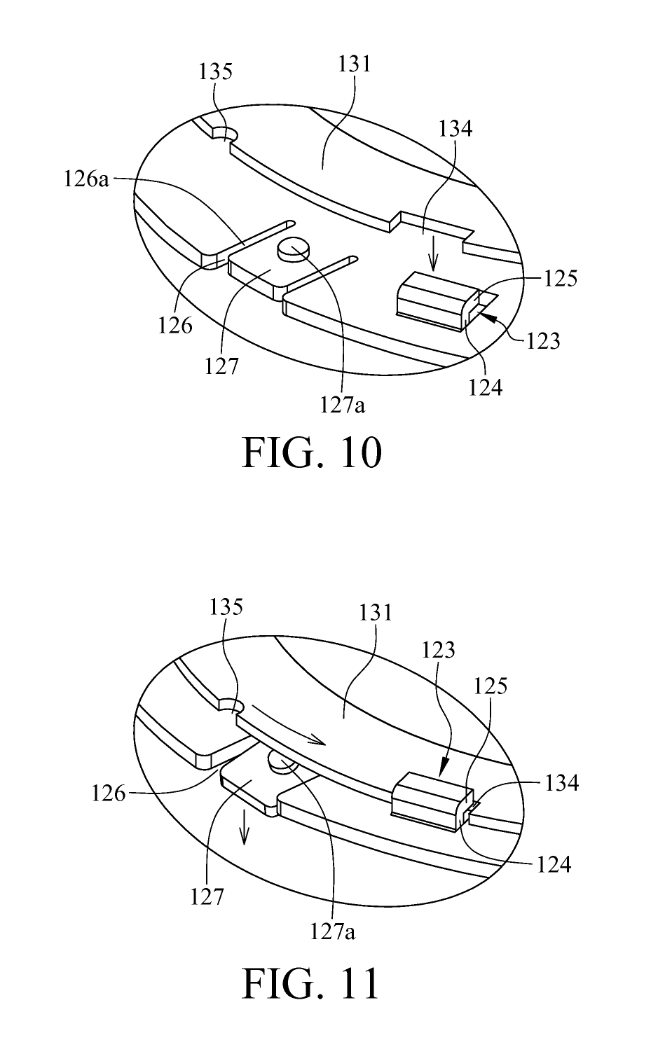

With reference to FIGS. 10, 11 and 12, in this embodiment, the way to assemble the second mounting base 120 and the substrate 131 is described as below: disposing the substrate 131 on the bearing surface 122 of the bearing board 121 after making each of the positioning holes 134 of the substrate 131 and each of the limiting members 123 of the second mounting base 120 directly aligned. That is to say, the second coupling feature (limiting member 123) is not in contact with the fourth coupling feature (top surface of the substrate 131), oppositely, the second coupling feature is aligned with each of the positioning holes 134 of the substrate 131. Referring to FIG. 10, each of the elastic positioning boards 127 moves backward to the direction of each of the accommodating holes 126 owning to the reason that the substrate 131 contacts against the positioning pillars 127a of the elastic positioning boards 127. That is to say, the first coupling feature (positioning pillar 127a) and the third coupling feature (limiting hole 135) are not aligned from each other.

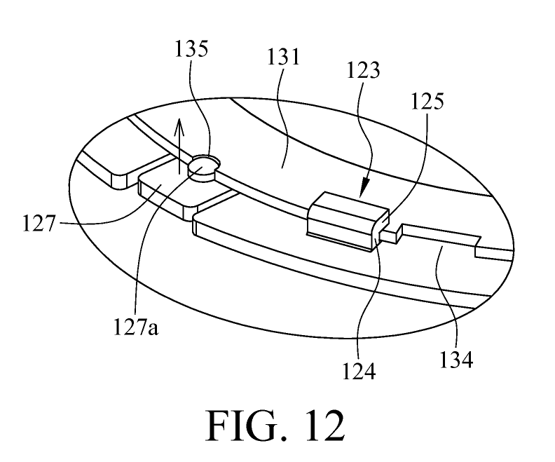

Referring to FIG. 12, rotating the substrate 131 to make each of the limiting holes 135 of the substrate 131 align with the positioning pillar 127a of each of the elastic positioning members 127. Each of the elastic positioning members 127 is restored by means of an elastic force, each of the positioning pillars 127a penetrates through each of the limiting holes 135 to make the position of the substrate 131 firmly fixed to the second mounting base 120. That is to say, the first coupling feature (positioning pillar 127a) and the third coupling feature (limiting hole 135) are mutually aligned and coupled so as to limit the substrate 131 from rotation. On the contrary, the second coupling feature (limiting member 123) and the fourth coupling feature (top surface of the substrate 131) are mutually in contact and coupled to assure that the substrate 131 is firmly stackable to the second mounting base 120 rather than axially or radially separating the second mounting base 120.

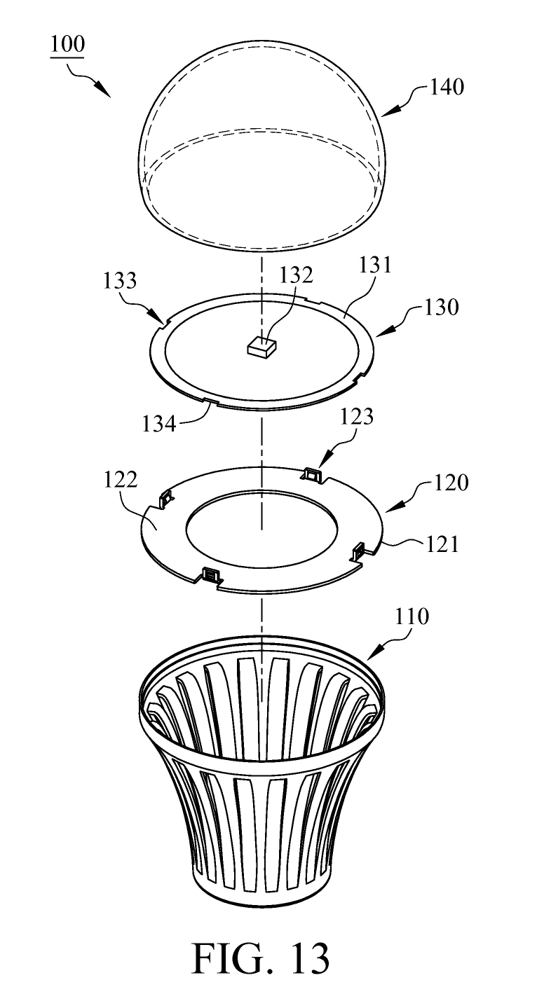

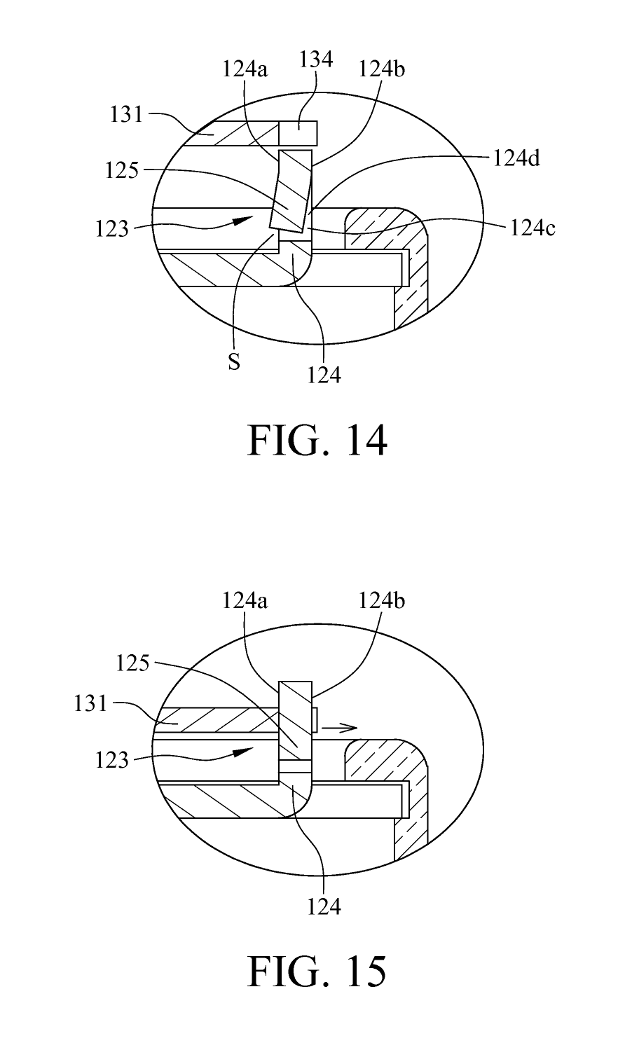

With reference to FIGS. 13 and 14, a sixth embodiment of the present invention is disclosed, the primary difference between the sixth embodiment and the fourth embodiment is that the first positioning board 124 of each of the limiting members 123 comprises a first surface 124a, a second surface 124b and a through hole 124c, each of the through holes 124c is in communication with each of the first surfaces 124a and each of the second surfaces 124b. Each of the second positioning boards 125 of the limiting member 123 is protruded to each of the first surfaces 124a by stamping process. Each of the through holes 124c comprises a hole wall 124d, and each of the second positioning boards 125 is connected to each of the hole walls 124d.

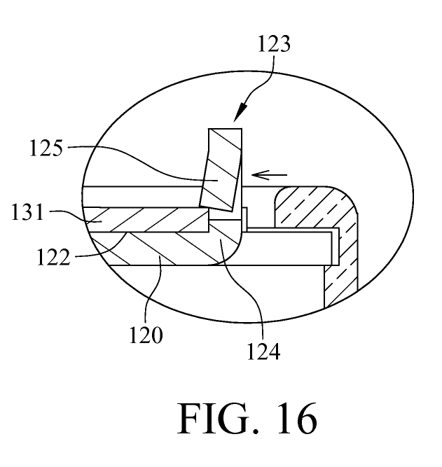

With reference to FIGS. 14, 15 and 16, in this embodiment, the way to assemble the second mounting base 120 and the substrate 131 is described as below: making each of the positioning holes 134 of the substrate 131 and each of the limiting members 123 of the second mounting base 120 mutually aligned. Referring to FIG. 15, making each of the second positioning boards 125 moves backwardly for the substrate 131 is in contact with the second positioning board 125. Referring to FIG. 16, pressing the substrate 131 so as to make the substrate 131 constrained within the limiting space S. Besides, the second positioning board 125 is restored via an elastic force to make the substrate 131 firmly fixed on the bearing surface 122 of the second mounting base 120.

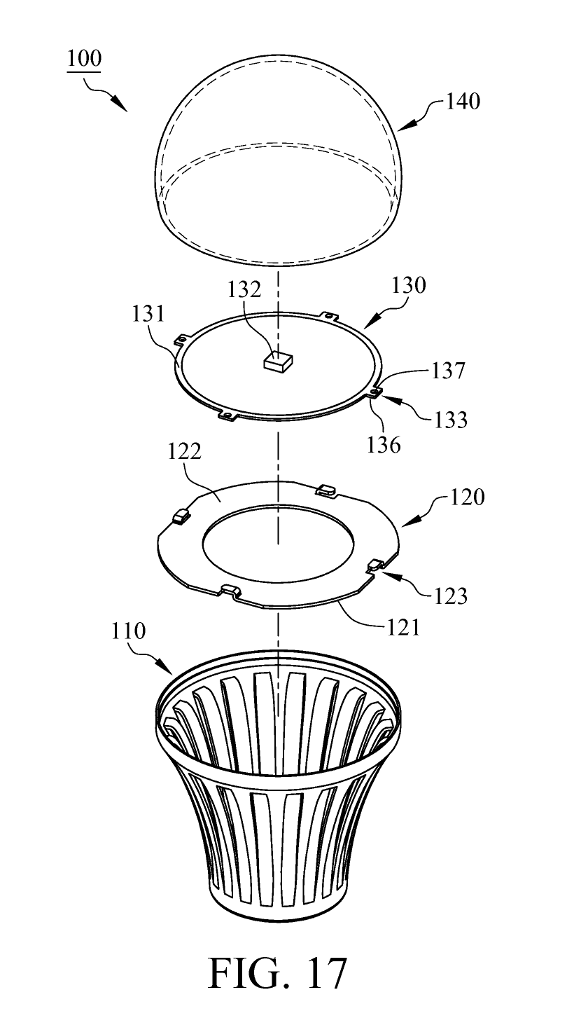

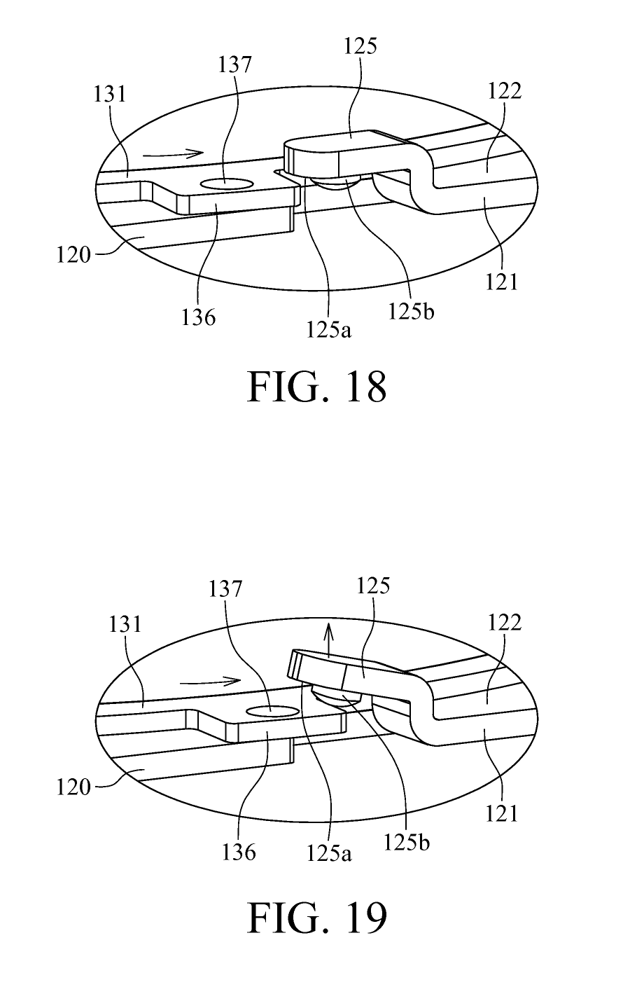

With reference to FIGS. 17 and 18, a seventh embodiment of the present invention is disclosed, the primary difference between the seventh embodiment and the fourth embodiment is that the positioning portions 133 of the substrate 131 in the seventh embodiment are a plurality of fixing boards 136 protruded to an exterior peripheral of the substrate 131. The first coupling feature is a fixing pillar 125b of each of the second positioning boards 125, the second coupling feature is a lower surface 125a of each of the second positioning boards 125, the lower surface 125a faces toward the bearing surface 122, and each of the fixing pillars 125b is protruded to each of the lower surfaces 125a. The third coupling feature is a fixing hole 137 of each of the fixing boards 136, and the fourth coupling feature is a top surface of each of the fixing boards 136.

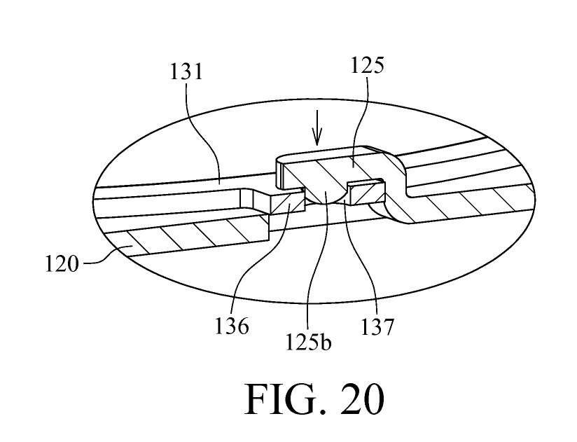

Referring to FIGS. 18, 19 and 20, in this embodiment, the way to assemble the second mounting base 120 and the substrate 131 is described as below: disposing the substrate 131 on the bearing surface 122 of the bearing board 121, meanwhile, the first coupling feature (fixing pillar 125b) and the third coupling feature (fixing hole 137) are not mutually aligned, the second coupling feature (lower surface 125a of the second positioning board 125) is not in contact with the fourth coupling feature (top surface of the fixing board 136). With reference to FIG. 19 again, the fixing board 136 contacts against the fixing pillar 125b of each of the second positioning boards 125 during the rotation of the substrate 131 to make each of the second positioning boards 125 move upwardly. With reference to FIG. 20, When each of the fixing pillars 125b is aligned with each of the fixing holes 137, each of the second positioning boards 125 is restored via an elastic force, and thereafter making each of the fixing pillars 125b penetrate through each of the fixing holes 137. By constraining each of the fixing pillars 125b within each of the fixing holes 137, the rotation of the substrate 131 can be prevented. That is to say, the first coupling feature (fixing pillar 125b) and the third coupling feature (fixing hole 137) are mutually aligned and coupled to limit the substrate 131 from rotation. On the contrary, the second coupling feature (lower surface 125a of the second positioning board 125) and the fourth coupling feature (top surface of the fixing board 136) are mutually in contact and coupled so as to make the substrate 131 firmly stacked to the second mounting base 120 rather than axially or radially separating the second mounting base 120.

The fourth, fifth, sixth and seventh embodiments prevent the substrate 131 of the lamp assembly from separating the second mounting base 120 or from clockwise/counterclockwise rotation to avoid damages of the circuit board or electric wires electrically connected to the illuminating device 132 by constraining each of the positioning portions 133 of the substrate 131 within each of the limiting members 123 of the second mounting base 120.

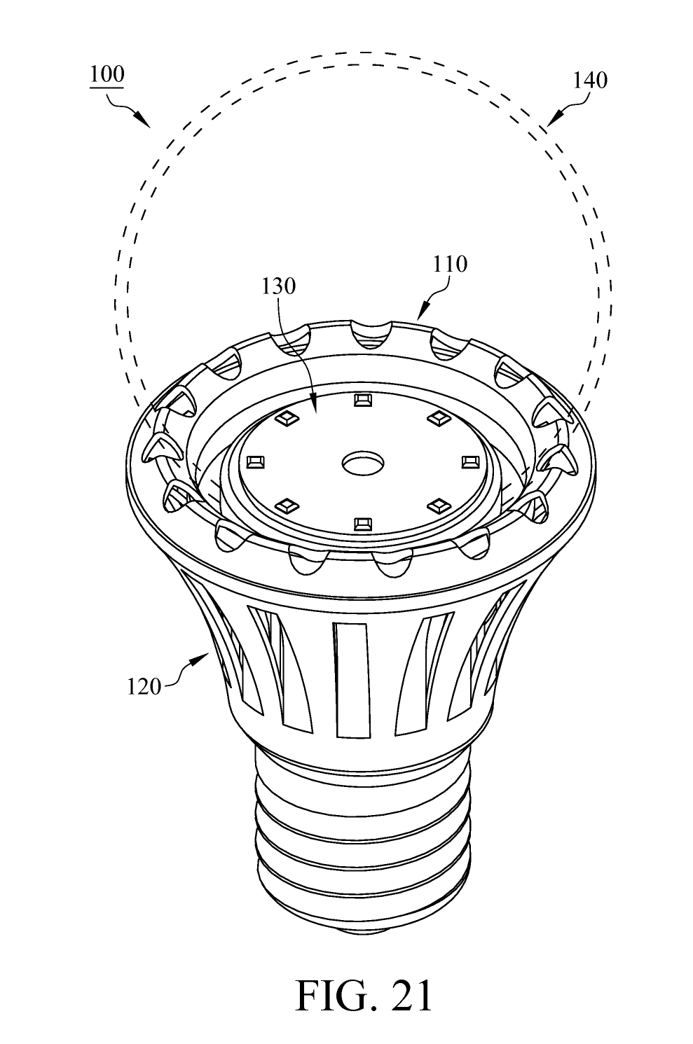

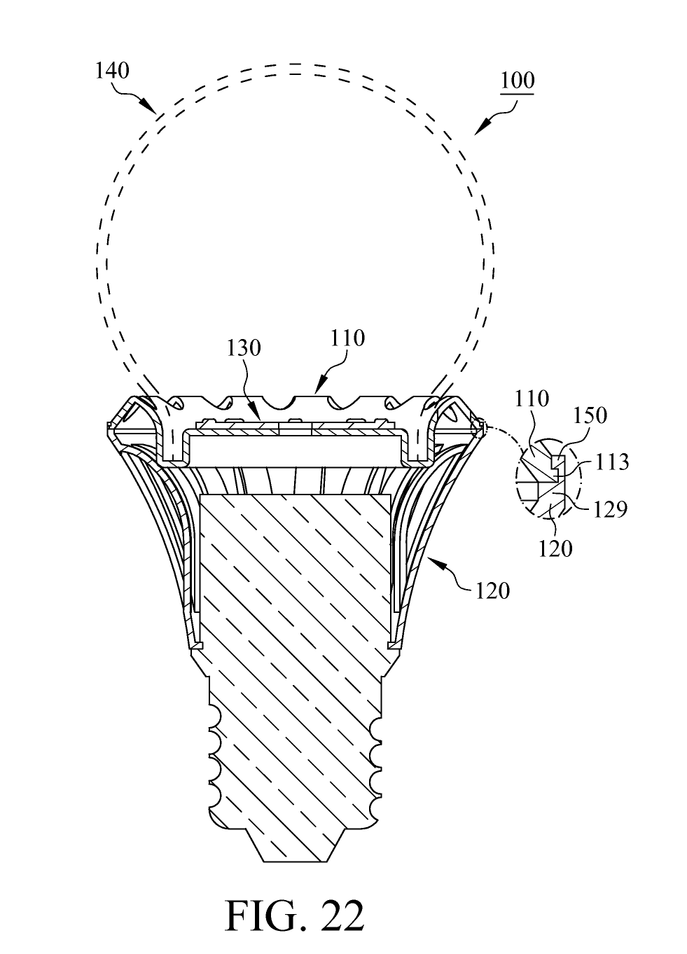

With reference to FIGS. 21 and 22, an eighth embodiment of the present invention is disclosed, a mounting structure 100 of a lamp assembly includes a first mounting base 110 and a second mounting base 120 mutually combined with the first mounting base 110, wherein a lighting module 130 and a lamp cover 140 are coupled to the first mounting base 110. The first mounting base 100 comprises a blocking portion 113, the second mounting base 120 comprises a limiting portion 129 and a clamping portion 150 connected to the limiting portion 129, the clamping portion 150 is deformable in response to forces, the blocking portion 113 of the first mounting base 110 is limited between the clamping portion 150 and the limiting portion 129 therefore forming into a concealed state.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A mounting structure of a lamp assembly, wherein the lamp assembly includes a lighting module disposed on the mounting structure and a lamp cover for dispersing light from the lighting module, the mounting structure at least includes a first mounting base and a second mounting base mutually combined with the first mounting base, wherein the first mounting base comprises a blocking portion, the second mounting base comprises a limiting portion and a clamping portion connected to the limiting portion, the clamping portion is deformable in response to forces, the blocking portion of the first mounting base is limited between the clamping portion and the limiting portion so as to make the blocking portion formed as a concealed state.

2. The mounting structure of a lamp assembly in accordance with claim 1, wherein the blocking portion comprises a top surface, a bottom surface and a lateral surface connected to the top surface and the bottom surface, the top surface, the bottom surface and the lateral surface are concealed by the clamping portion and the limiting portion.

3. The mounting structure of a lamp assembly in accordance with claim 1, wherein the clamping portion surrounds the blocking portion, the clamping portion is not pushed and compressed by the blocking portion so that the clamping portion is not deformed, the clamping portion is deformed while an exerting force is applied to the clamping portion.

4. The mounting structure of a lamp assembly in accordance with claim 1, wherein the second mounting base comprises a plurality of insertion slots, the lamp cover comprises a plurality of insertion plates, the lighting module comprises a plurality of openings, and each of the insertion plates lodges into each of the insertion slots via each of the openings.

5. The mounting structure of a lamp assembly in accordance with claim 1, wherein the lighting module is coupled to the second mounting base.

6. The mounting structure of a lamp assembly in accordance with claim 1, wherein the lighting module is coupled to the first mounting base.

7. The mounting structure of a lamp assembly in accordance with claim 1, wherein the second mounting base further comprises a heat-dissipating portion connected to the limiting portion, the heat-dissipating portion comprises a plurality of heat-dissipating holes.

8. The mounting structure of a lamp assembly in accordance with claim 1, wherein the first mounting base further comprises a plurality of heat-dissipating openings and a plurality of heat-dissipating ribs, each of the heat-dissipating openings comprises a lateral wall, and each of the heat-dissipating ribs is formed at each of the lateral walls.

9. The mounting structure of a lamp assembly in accordance with claim 7, wherein the heat-dissipating portion comprises a first heat-dissipating portion and a second heat-dissipating portion, the first heat-dissipating portion is located between the limiting portion and the second heat-dissipating portion, and an included angle is defined between the first heat-dissipating portion and the second heat-dissipating portion.

10. The mounting structure of a lamp assembly in accordance with claim 9, wherein the included angle is not larger than 180 degrees.
